(19) United States
(12) Patent Application Publication
(10) Pub. No.: US 2011/0131752 A1
(43) Pub. Date: Jun. 9, 2011

(54) SYSTEM, METHOD AND APPARATUS FOR PRESSURE CLEANING

(76) Inventor: Don Place, Wesley Chapel, FL (US)

(21) Appl. No.: 12/958,482

(22) Filed: Dec. 2, 2010

Related U.S. Application Data
(60) Provisional application No. 61/266,415, filed on Dec. 3, 2009.

(51) Int. Cl. A47L 7/00; B08B 3/00

(52) U.S. Cl. 15/320; 134/105

(57) ABSTRACT

An application for a pressure cleaning system that is mounted on a vehicle and has an engine for moving the vehicle, generating electrical power as needed, providing water pressure, providing vacuum and optionally providing hydraulic pressure. Water is stored in a holding tank and pressurized for application to a surface to be cleaned. Water in the holding tank is heated from waste heat produced by the engine and or by the hydraulic system.

### CROSS-REFERENCE TO RELATED APPLICATION

This application is a non-provisional application related taking priority from U.S. provisional patent application Ser. No. 61/266,415, filed Dec. 3, 2009, the disclosure of which is hereby incorporated by reference.

### FIELD

This invention relates to the field of surface cleaning and more particularly to a system for cleaning large surface areas with pressurized, heated water.

### BACKGROUND

It is well known to use high-pressure water to clean surfaces such as pavements, etc. Furthermore, it is well known to use heated, high-pressure water as an improved way to clean such surfaces, especially when the surface is soiled with substances such as oil, grease, gum, etc.

Pressure washers and heated pressure washers are known in the industry. Existing devices require sources of water such as a garden hose and fuel or electricity to pressurize the water and, if provided, to heat the water. These devices are useful for small areas such as walkways to one's home, small patios, etc, but fall short on large areas such as parking garages, sidewalks, streets, runways, etc. Due to their single, targeted nozzle, such devices inconsistently clean under the control of a person resulting in uneven cleaning and often visible stripes. Furthermore, such devices create an environmental problem. As these devices free oil, grease and other toxic materials from the surfaces, these toxic materials flow along with excess water into the drainage system and, eventually, into lakes, rivers, oceans, etc.

Attempts have been made to create automated devices that have a series of nozzles or rotating nozzles mounted to a motorized system containing pressure pumps and water storage tanks. This helps with the problem of pavement cleaning, but does not prevent or reduce the pollution problems. Newer designs have included electric or diesel heaters to heat the water, but these heaters require additional energy to operate, thereby further detracting from the environment. For example, U.S. Pat. No. 6,578,714 to Rohrbacher, et al, discloses a Mobile Washer with Fluid Reclamation System. In this, a discrete heater 78 is used to heat the water that is later used in the pressure cleaning. This heater used fuel to heat the water to the required temperature. This is not energy-efficient being that additional fuel is used, above and beyond the fuel used to create the pressure and reclaim the water after cleaning.

Later attempts at such devices have included vacuum systems to retrieve the soiled/polluted water, filter out dirt and pollutants and recycle the water to the water storage supply. These devices still require extra energy to heat the water and have other shortcomings for cleaning large areas as well as cleaning narrow, long areas such as curbs or gutters.

What is needed is an energy-efficient system that will clean a variety of large surfaces with high-pressure hot water.

### SUMMARY

The pressure cleaning system is mounted on a vehicle and has an engine for moving the vehicle, generating electrical power as needed, providing water pressure, providing vacuum and optionally providing hydraulic pressure. Water is stored in a holding tank and pressurized for application to a surface to be cleaned. Water in the holding tank is heated from waste heat produced by the engine and or by the hydraulic system.

In one embodiment, a surface cleaning apparatus is disclosed including an engine and at least one power washer pump rotatably coupled to the engine. A holding tank is fluidly coupled to the power washer pump(s), thereby supplying cleaning fluid to the power washer pump(s). A nozzle system is fluidly coupled to high-pressure outputs of the power washer pump(s), directing high pressure cleaning fluid onto a surface to be cleaned. A heat exchanger within the holding tank is fluidly coupled to a fluid cooling system of the engine. The heat exchanger accepts engine coolant from the engine, transferring heat from the engine coolant to the cleaning fluid within the holding tank and returns the engine coolant back to the engine, thereby heating the cleaning fluid within the holding tank and cooling the engine.

In another embodiment, a surface cleaning apparatus is disclosed including a vehicle having wheels and an engine mounted to the vehicle. A holding tank for containing cleaning fluid and a system for pressurizing the cleaning fluid is mounted to the vehicle. The system for pressurizing the cleaning fluid fluidly is coupled to the holding tank. A system for directing the cleaning fluid under pressure onto a surface to be cleaned is provided. The cleaning fluid is heated by at least heat generated by the engine and optionally heat from an exhaust of the engine, optionally heat from a hydraulic system and optionally heat from an auxiliary heater.

In another embodiment, a surface cleaning apparatus is disclosed including a vehicle having wheels with an engine mounted to the vehicle. The surface cleaning apparatus has at least one power washer pump rotatably coupled to the engine, each of which are fluidly connected to a supply of cleaning fluid and a nozzle system fluidly coupled to high-pressure outputs of the power washer pumps. The nozzle system directs pressurized cleaning fluid onto a surface to be cleaned. The cleaning fluid is heated by three heat exchangers. A first heat exchanger has a first section that is fluidly coupled to a fluid cooling system of the engine and a second section fluidly coupled to the supply of cleaning fluid thereby transferring heat from the engine coolant to the cleaning fluid to heat the cleaning fluid and to cool the engine. A second heat exchanger has a first section that is fluidly coupled to an exhaust of the engine and a second section that is fluidly coupled to the supply of cleaning fluid thereby transferring heat from the exhaust of the engine to the cleaning fluid to heat the cleaning fluid. A third heat exchanger has a first section that is fluidly coupled to a hydraulic fluid system and a second section that is fluidly coupled to the supply of cleaning fluid, thereby transferring heat from the hydraulic fluid system to the cleaning fluid to heat the cleaning fluid.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of the pressure cleaning system.

FIG. 2 illustrates a top plan view of the pressure cleaning system.

FIG. 3 illustrates a side plan view of the pressure cleaning system.

FIG. 4 illustrates a second side plan view of the pressure cleaning system.

FIG. 5 illustrates a schematic view of an exemplary cleaning deck of the pressure cleaning system.

FIG. 6 illustrates a schematic view of a second exemplary cleaning deck of the pressure cleaning system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

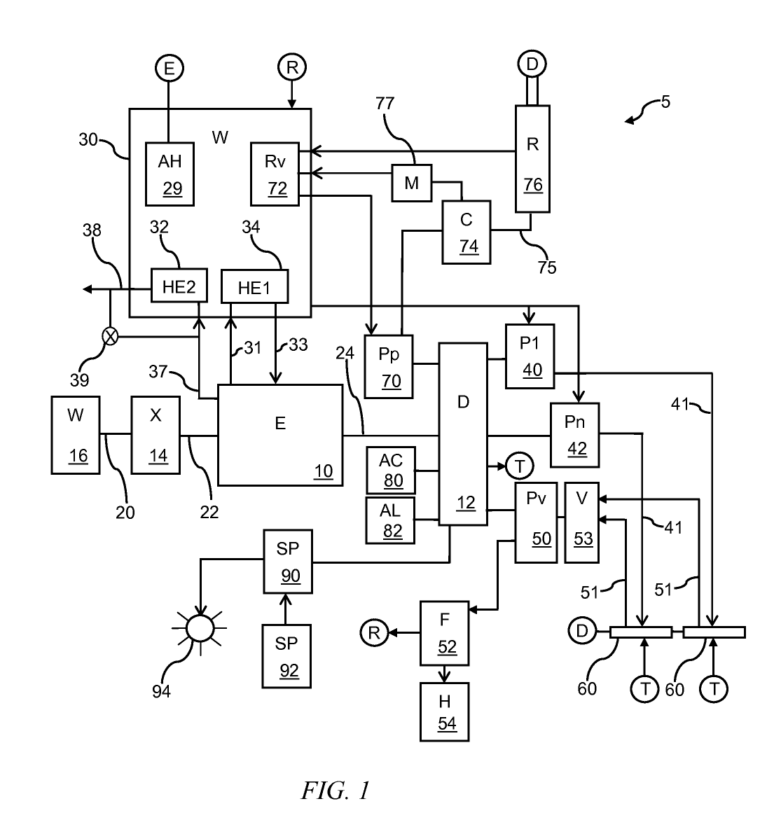

Referring to FIG. 1, a schematic view of the pressure cleaning system is shown. The entire system 5 is mounted on/to a wheeled vehicle and operated by energy created by an engine 10. Many types of engines 10 are known in the industry including diesel, gasoline, hydrogen and hybrids using both stored electrical energy and fossil fuel. Although many configurations of rotational connections are possible, this exemplary system has the main drive shaft 22 interfaced to a transmission 14 and the transmission 14 is interfaced to one or more wheels 16 by an axle 20 or other similar interface. With such, the system 5 is provided with movement capabilities to maneuver across the surface to be cleaned. It is preferred that one or more of the wheels 16 be pivotally connected to the system 5 and controlled by an operator (steered) so that the system 5 is driven similar to other vehicles over the surface to be cleaned.

Also in this example, the front crank shaft 24 of the engine 10 is coupled to several other components 40/42/50/70/80/82/90 through a drive belt 12 or other known gearing or coupling system. Rotation of the crankshaft 12 rotates shafts of each of these components 40/42/50/70/80/82/90 at the desired speed needed for each component by way of RPM reduction/increase of the drive belt 12 system.

One component interfaced to the drive system 12 is one or more pressure pumps 40/42. The pressure pumps 40/42 pressurize water (or any cleaning fluid) from the holding tank(s) 30 and supply such under pressure to one or more nozzles or nozzle systems 60.

Another component interfaced to the drive system 12 is a vacuum pump 50. After the water pressure from the nozzles 60 frees dirt, oil, etc, from the surface to be cleaned, the vacuum pump 50 pulls the contaminated water up from the surface around the nozzles 60 through vacuum pipes 51 into the vacuum tank 53 (e.g. settling tank) and through a filter system 52 to remove the contaminants. The contaminants remain in the filter system 52 and/or a holding tank 54 while the filtered water (or cleaning agent, etc) flows back into the holding tank 30. After cleaning of the surface is finished, the contaminants are cleaned from the filter system 52 and/or holding tank 54 and disposed of in an environmentally friendly way. Through this mechanism, most of the water used in pressure washing is reclaimed, thereby reducing water consumption to around, for example, 10% of an equivalent system without a vacuum system 50/52/53/54. Furthermore, due to environmental reasons, it is desirable to capture as much grease, oil and other contaminants that are toxic to the environment. These contaminants are vacuumed along with the reclaimed water and removed by the filter system 52/54 and, later disposed of in approved, environmentally friendly ways.

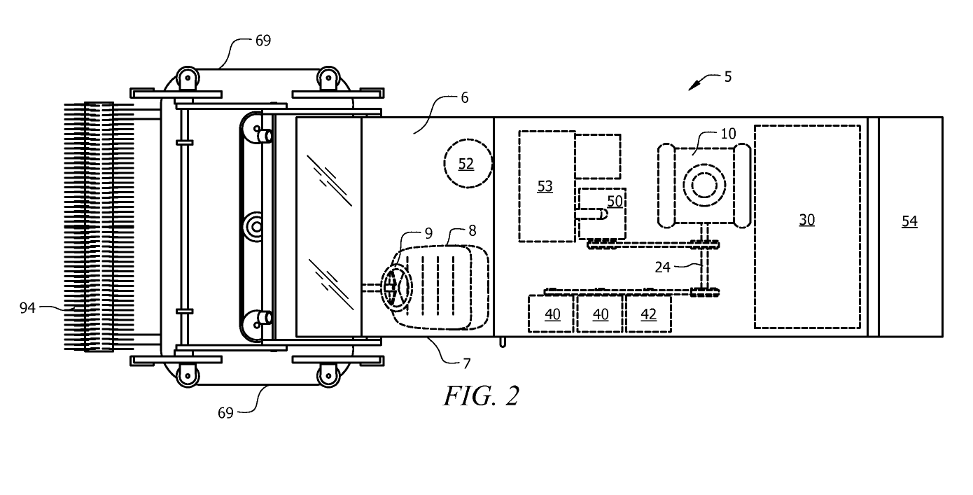

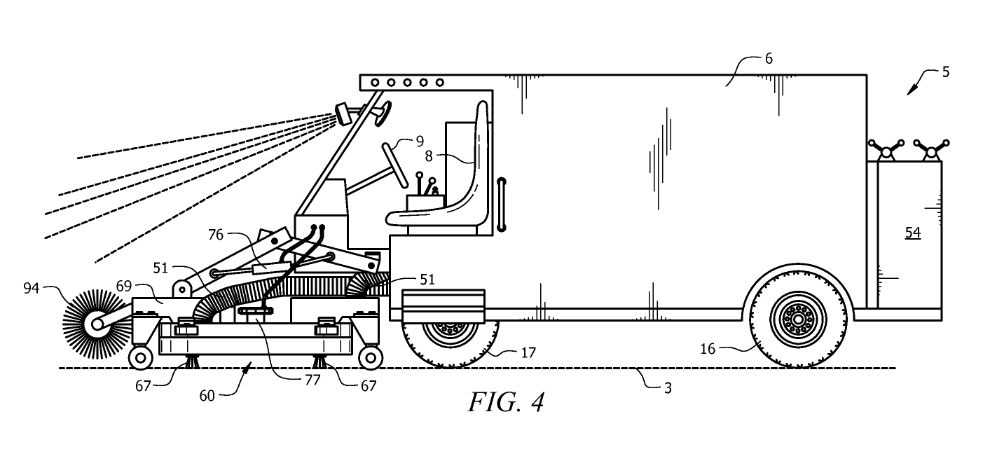

Another component optionally interfaced to the drive system 12 is a hydraulic or pneumatic pump 70. The hydraulic pump 70 provides hydraulic pressure to operate one or more hydraulic rams 76 or hydraulic motors 77 under the control of one or more control valves 74 as known in the industry. The rams 76 and/or motors 77 provide steering and/or lifting motion to various system components. For example, one ram 76 is interfaced to the decks 69 (see FIGS. 2-4) to raise and lower the decks 69 for maneuvering, swapping with other decks 69 and storage. Another hydraulic motor 77 turns the nozzle system 60, etc. Any other linear and/or rotating source of energy is anticipated for moving various components such as the decks 69, the rotating nozzles 60, steering, etc.

Another optional component of the cleaning system 5 is a cleaning agent applicator. In such, the drive system 12 is interfaced to a cleaning agent dispensing pump 90. In these embodiments, a cleaning agent such as soap or detergent is pumped from a tank 92 to an applicator 94 and the applicator is positioned ahead of the nozzle system 60 to pre-coat the surface to be cleaned with the cleaning agent before the high pressure water is used to finish the cleaning. In such embodiments, the applicator 94 is a brush, a sprayer, a rotating brush or any known applicator.

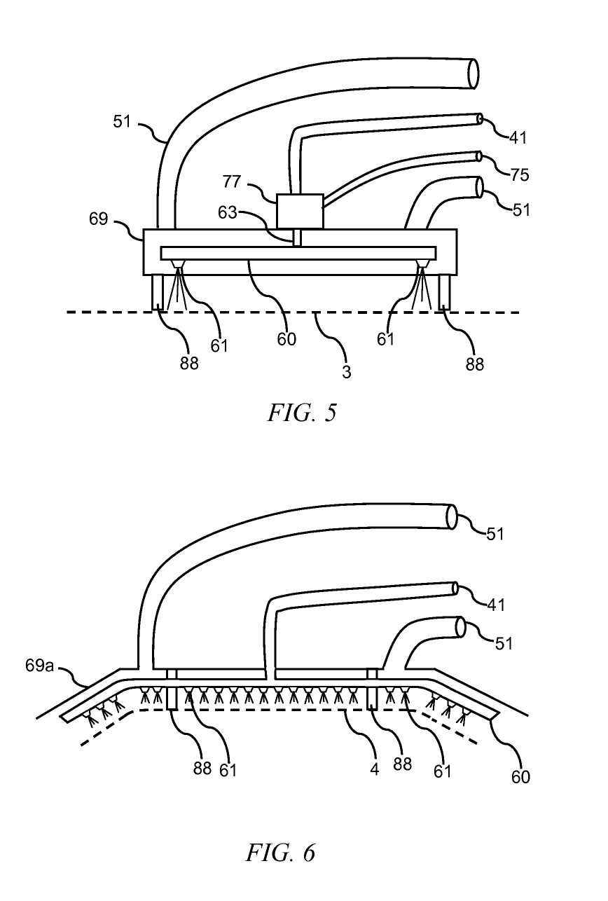

In some embodiments, the nozzles 60 include a rotating assembly similar to a lawn mower blade system. The high pressure water passes through the shaft 63 (see FIG. 5) of the rotating system and high-pressure water is emitted from nozzles 61 (see FIG. 5) on the bottom of the blades, cleaning in a circular pattern. The shafts are also coupled to a source of rotational energy such as the hydraulic motor 77 for turning motion.

It is anticipated that some or all of the components 40/42/50/70/80/82 that are interfaced to the drive system 12 have gearing systems, pulley systems and/or clutch systems to provide rotational speed increases/decreases and/or stopping while the engine 10 maintains a predetermined speed. It is also anticipated that the speed of the engine 10 is controlled to provide an adjustable speed of motion of the vehicle 5.

As known in the automotive/truck industry, other components are interfaced to the engine 10 as needed such as air conditioning compressors 80 and alternators (or generators) 82.

For many cleaning situations, it is advantageous to heat the water before pressure washing to remove difficult contaminants such as oil, grease, chewing gum, etc. Prior systems passed the water from a holding tank 30 through a discrete water heater then to the pumps 40/42. For example, U.S. Pat. No. 6,578,714 to Rohrbacher, et al, has a discrete heater 78 that is used to heat the water that is later used in the pressure cleaning.

Systems with heaters to heat the water (fluid) have several problems related to the heater itself. For one, extra energy was used to heat the water. Many such systems used a burner system with a fuel such as propane or diesel or an electric heating element. In such, extra fuel or a power generator is needed to operate the water heater. The heating elements or burners often fail, get clogged, etc. Such heaters often require a different fuel than that which is used to propel the cleaning system and such heaters create extra heat and pollution that is exhausted from the prior art systems. Furthermore, the heaters and extra fuel add weight to the system, further reducing efficiency in operation as well as efficiency in transporting the system to the surface to be cleaned.

To overcome this problem, one or more sources of waste heat are coupled to the water holding tank 30 to heat the water (fluid) without the need of a separate water heater. In some embodiments, most of the heat is from such sources and it is anticipated that a small auxiliary water heater 29 is provide for the startup cycle or when higher temperatures are required. Although there are many sources of waste heat that is useful in heating the water (fluid), three examples of utilizing waste heat are optionally used for water heating. The first example uses engine heat from the engine 10. The second example captures waste heat from the exhaust 36 of the engine 10. The third example uses waste heat from the hydraulic system 70/72/74/75/76.

In the first example, coolant from the engine's 10 water pump is routed through plumbing 31 to a heat exchanger 34 within the holding tank 30 and then back to the engine 10 through return plumbing 33. The coolant (e.g. water and/or antifreeze) passes through jackets within the engine 10 and removes heat from the engine 10 as known in the industry. The heat is then released from the water within the holding tank 30 by the heat exchanger 34. In some embodiments, the heat exchanger 34 includes a grid of passages and/or fins to provide as much surface area to heat the water within the holding tank 30. In some embodiments, the heat exchanger 34 is a coil of metal tubing with or without fins. There are many known constructions for heat exchangers 34, all of which are anticipated here within. Heat exchangers 34 are well known in the industry having a first side that is fluidly insulated from a second side yet thermally conductive between the sides. Therefore, the fluid from the first side does not mix with the fluid from the second side but heat is conducted from the fluid in the first side to the fluid in the second side.

In the second example, hot exhaust gases from the engine 10 are routed through exhaust tubing 37 to a second heat exchanger 32 and then out through an exhaust pipe 38. The hot exhaust gases heat the second heat exchanger 32 which is in contact with the water within the holding tank 30, thereby heating the water. In some embodiments, the second heat exchanger 32 includes a grid of passages and/or fins to provide as much surface area to heat the water within the holding tank 30. In some embodiments, the heat exchanger 32 is a coil of metal tubing or exhaust pipe with or without fins. There are many known constructions for heat exchangers 32, all of which are anticipated here within. It is anticipated that, in some embodiments, a bypass valve 39 is provided such as a butterfly valve interfaced between the exhaust tubing 37 and the exhaust pipe 38 for bypassing the second heat exchanger 32. In this embodiment, when the water in the holding tank 30 reaches a predetermined temperature, the exhaust gases bypass the second heat exchanger 32 through the bypass valve 39, thereby reducing the amount of heat provided to the water.

In the third example, the hydraulic reservoir 72 or hydraulic heat exchanger 72 is housed within the holding tank 30 providing an additional source of heat to the water within the holding tank 30 that is in contact with the hydraulic reservoir 72/heat exchanger 72. As hydraulic fluids are compressed during pumping by the hydraulic pump 70 and operation of the hydraulic ram 76, the hydraulic fluids heat, generally as high as 200 degrees Fahrenheit. By housing the hydraulic reservoir 72 within the holding tank 30 and immersed in the water (fluid), heat is transferred from the hydraulic fluid into the water. This not only heats the water, but cools the hydraulic fluid. In some embodiments, the reservoir 72 is external to the holding tank 30 and, for cooling of the hydraulic fluid and heating of the water, a separate heat exchanger (not shown) is provided within the holding tank 30 to transfer heat from the hydraulic fluid to the water in the holding tank 30.

Any combination of the disclosed water heating mechanisms is anticipated including one, two, three or all four mechanisms. It is also anticipated that an auxiliary external heater be provided in cases where additional heat is needed. Also, even though shown in the best mode anticipated, other combinations and order of each subsystem is anticipated to achieve the same or similar functionality.

Additionally, the pressure cleaning system 5 does not need to be mounted on any specific vehicle. For example, one exemplary pressure washing system 5 includes a fossil fuel engine (e.g. gasoline, propane, etc) coupled to a pressure pump. The pressure pump receives water (e.g. cleaning fluid) from a holding tank and the water in the holding tank is heated by heat from the engine (coolant and/or exhaust). Such a system is anticipated to be stand-alone, mounted to a wheel base or mounted to a skid for placement onto a bed of a truck, etc.

Referring to FIG. 2, a first plan view of the pressure cleaning system 5 is shown. In this exemplary system, a vehicle 6 is shown having the cleaning system as described above. The deck 69 that houses the nozzle system 60 is preferably in the front of the vehicle 6. It should be noted that, in the preferred embodiment, the nozzle system 60 extends beyond at least one side 7 of the vehicle 6 for cleaning gutters, etc. Also, in the preferred embodiment, the deck 69 and nozzle system 60 is removable and exchangeable with alternate decks 69 and nozzle systems 60. The deck 69 and nozzle system 60 shown in this example is preferred for large areas such as garages, walkways, runways, etc. To Clean Miami curbs, a different nozzle system 60a (not shown) is attached to the front of the vehicle 6 that cleans the concrete portion of a Miami curb. For traditional curbs, a nozzle system is attached that aims the high pressure water on the various surfaces of that design of curb. Any deck 69 and nozzle system 60 configuration is anticipated. In some embodiments, the deck 69 is at least partially supported by wheels.

In some embodiments, pressurized air is blown from the front and/or side area of the deck 69 to reduce sand, leaves and other debris from the surface before pressure cleaning. This reduces the amount of such debris that is sucked up by the vacuum system.

Visible from the top is a seat 8 and controls 9 (e.g. steering wheel) for the operator. The top of the engine 10 is visible along with the vacuum pump 50 and associated vacuum tank 53, multiple power washer pumps 40/42 are coupled to the engine's 10 crankshaft 24. The filter 52, the vacuum holding tank 54 and the water (fluid) tank 30 are located for ease of access and weight distribution. Although shown in a fixed configuration, any location, size and distribution of the components 10/24/30/40/50/52/54 is anticipated.

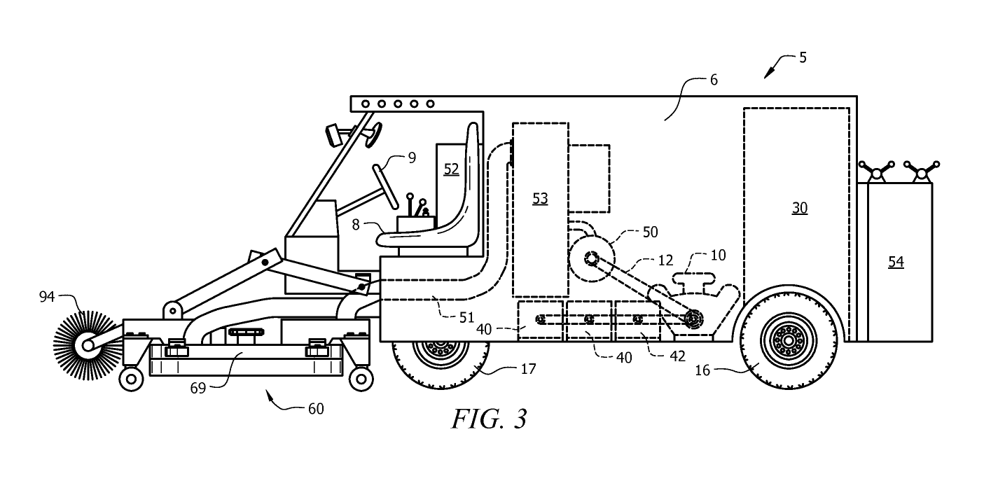

Referring to FIG. 3, a second plan view of the pressure cleaning system 5 is shown. In this exemplary system, a vehicle 6 is shown having the cleaning system as described above. The deck 69 with the nozzle systems 60 is preferably removably mounted in the front of the vehicle 6 for best correlation to the operator's vision. In a preferred embodiment, deck 69 and the nozzle system 60 is removable and exchangeable with alternate decks 69 and nozzle systems 60. The deck 69 and nozzle system 60 shown in this example is preferred for large areas such as garages, walkways, runways, etc. To Clean Miami curbs, a different nozzle system 60a (not shown) is attached to the front of the vehicle 5 that only cleans the concrete portion of a Miami curb. For traditional curbs, a nozzle system is attached that aims the high pressure water on the various surfaces of that design of curb.

In this view, the seat 8 and controls 9 for the operator are shown. The engine 10 interfaces with the vacuum pump 50 by a drive belt 12. The vacuum pump 50 interfaces to the vacuum tank 53, filter 52 and filter holding tank 54 through tubing that is not visible (see FIG. 1). Several water pumps 40/42 are also coupled to the engine's 10 crankshaft 24.

In this example, the rear wheel(s) 16 are coupled to the engine 10 by a drive shaft and rear-end as known in the industry to provide linear motion (not shown). It is preferred that any or all wheels 16/17, preferably the front wheel(s) 17, are coupled to the controls 9 for steering the vehicle 6. It is preferred that the front wheels 17 are able to turn up to 90 degrees in each direction, providing the ability to get into tight spaces such as the corners of parking garages.

Also shown is a cleaning agent dispenser 94. In some embodiments, a cleaning agent such as soap or detergent is pumped from a tank 92 (see FIG. 1) by a pump 90 and onto an applicator 94. The applicator is preferably positioned ahead of the deck 69 and nozzle system 60 to pre-coat the surface to be cleaned with the cleaning agent before the high pressure water is used to finish the cleaning. In such embodiments, the applicator 94 is a brush, a sprayer, a rotating brush or any known applicator.

In this example, a hydraulic ram 76 connects the deck 69 and the main body of the vehicle 6 for automated lifting of the deck 69. Also, in this example, a hydraulic motor 77 is interfaced to the deck 69 and nozzle system 60 for rotating the nozzles 61 (see FIGS. 5 and 6) and spraying the surface with high-pressure water (liquid) 67. Although shown attached to the back of the vehicle 6, the vacuum water holding tank 54 is located anywhere on the system 5. It is preferred that the holding tank 54 be located in a convenient position for removal and proper disposal of collected waste. The vehicle 6 is shown cleaning a flat surface 3, though other surfaces 4 (see FIG. 6) that are not flat are anticipated.

Referring now to FIG. 5, a side view of a deck 69 for cleaning substantially flat surfaces 3 is shown. Within the deck 69 is the nozzle system 60 with one or more nozzles 61 for spraying pressurized water (fluid) onto the surface 3 to clean the surface 3. In this example, the nozzle system 60 is rotated on a shaft 63 by a motor 77 (e.g. hydraulic motor 77). The hydraulic motor 76 is provided hydraulic fluid through high-pressure hydraulic lines 75. In this example, the shaft 63 is hollow and high pressure water from the pumps 40/42 is directed to the nozzle system 60 from high-pressure conduit 41 and through the shaft 63. Debris, pollutants, excess water (fluid), etc, are vacuumed up from the surface 3 through vacuum hoses 51. In some embodiments, wheels 88 at least partially support the deck 69.

Referring now to FIG. 6, a side view of a deck 69a for cleaning median islands 4 of a highway is shown. Within the deck 69a is the nozzle system 60 with several nozzles 61 for spraying pressurized water (fluid) onto the surface 4 to clean the surface 4. In this example, the nozzle system 60 is fixed and matches the contour of the median island 4. High pressure water from the pumps 40/42 is directed to the nozzle system 60 from high-pressure conduit 41. Debris, pollutants, excess water (fluid), etc, are vacuumed up from the surface 4 through vacuum hoses 51. In some embodiments, the angle and width of the nozzle system 60 is adjustable. There are many anticipated arrangements of nozzles 61 for cleaning various surface configurations such as Miami curbs, rolled curbs, right-angled curbs, etc, all of which are included here within. In some embodiments, wheels 88 at least partially support the deck 69a.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A surface cleaning apparatus comprising:
an engine;
at least one power washer pump rotatably coupled to the engine;
a holding tank, the holding tank fluidly coupled to the at least one power washer pump and supplying cleaning fluid to each of the at least one power washer pump;
a nozzle system fluidly coupled to high-pressure outputs of the at least one of the power washer pumps, the nozzle system directing the cleaning fluid under pressure from the at least one power washer pump onto a surface to be cleaned; and
a heat exchanger within the holding tank, the heat exchanger fluidly coupled to a fluid cooling system of the engine, the heat exchanger accepts engine coolant from the engine, transfers heat from the engine coolant to the cleaning fluid within the holding tank and returns the engine coolant back to the engine, thereby heating the cleaning fluid within the holding tank and cooling the engine.

2. The surface cleaning apparatus of claim 1, further comprising:
a second heat exchanger within the holding tank, the second heat exchanger fluidly coupled to an exhaust of the engine, the second heat exchanger accepting hot exhaust gases from the engine, transferring exhaust heat from the hot exhaust gases to the cleaning fluid within the holding tank and transferring the hot exhaust gases out through an exhaust pipe, thereby heating the cleaning fluid within the holding tank.

3. The surface cleaning apparatus of claim 1, further comprising:
a hydraulic reservoir within the holding tank, the hydraulic reservoir fluidly coupled to a hydraulic system, the hydraulic reservoir holding hydraulic fluid and transferring heat from the hydraulic fluid to the cleaning fluid within the holding tank, thereby heating the cleaning fluid within the holding tank.

4. The surface cleaning apparatus of claim 1, further comprising:
a vacuum system, an input of the vacuum system located in proximity of the nozzle system whereby the vacuum system picks up a majority of the cleaning fluid and materials from the surface, the vacuum system filters the cleaning fluid and materials from the surface, removing a majority of the materials from the surface and the vacuum system returns filtered cleaning fluid to the holding tank.

5. The surface cleaning apparatus of claim 1, wherein the nozzle system comprises a plurality of nozzles rotatably interfaced to a drive motor by a shaft, the shaft being hollow and the shaft interfaced to at least one of the power washer pumps, thereby providing the cleaning fluid under pressure to the nozzles.

6. The surface cleaning apparatus of claim 1, wherein the nozzle system comprises a plurality of nozzles interfaced to at least one of the power washer pumps, thereby providing the cleaning fluid under pressure to the nozzles.

7. The surface cleaning apparatus of claim 1, wherein the nozzle system is housed in a deck and the deck is removably attached to a vehicle for in-the-field exchange of the deck with a different deck.

8. The surface cleaning apparatus of claim 1, further comprising an applicator, the applicator providing a cleaning agent to the surface before the nozzle system cleans the surface.

9. The surface cleaning apparatus of claim 1, wherein the engine is coupled to the wheels of a vehicle through a transmission, thereby selectively moving the vehicle across the surface under operator control.

10. The surface cleaning apparatus of claim 1, further comprising an auxiliary heater coupled to the holding tank, the auxiliary heater providing additional heat to the cleaning fluid.

11. A surface cleaning apparatus comprising:
a vehicle having wheels;
an engine mounted to the vehicle;
a holding tank mounted to the vehicle, the holding tank containing cleaning fluid;
means for pressurizing the cleaning fluid, the means for pressurizing the cleaning fluid being fluidly coupled to the holding tank;
means for directing pressurized cleaning fluid onto a surface to be cleaned; and
means for heating the cleaning fluid from heat generated by the engine.

12. The surface cleaning apparatus of claim 11, further comprising:
means for heating the cleaning fluid from hot exhaust gases fro the engine.

13. The surface cleaning apparatus of claim 11, further comprising:
means for heating the cleaning fluid from hot hydraulic fluid.

14. The surface cleaning apparatus of claim 11, further comprising:
means for recovering contaminated cleaning fluid from the surface;
means for filtering the contaminated cleaning fluid, creating filtered cleaning fluid; and
means for transferring the filtered cleaning fluid into the holding tank.

15. The surface cleaning apparatus of claim 11, wherein the means for directing pressurized cleaning fluid onto the surface rotates, thereby providing the cleaning fluid under pressure to a wide surface area.

16. The surface cleaning apparatus of claim 11, wherein the means for directing pressurized cleaning fluid onto the surface includes a plurality of nozzles.

17. The surface cleaning apparatus of claim 11, wherein the means for directing pressurized cleaning fluid onto a surface is housed in a deck and the deck is removably attached to the vehicle for in-the-field exchange of the deck with a different deck.

18. A surface cleaning apparatus comprising:
a vehicle having wheels;
an engine mounted to the vehicle;
at least one power washer pump rotatably coupled to the engine, each of the power washer pumps fluidly connected to a supply of cleaning fluid;
a nozzle system fluidly coupled to high-pressure outputs of at least one of the at least one of the power washer pumps, the nozzle system directing pressurized cleaning fluid onto a surface to be cleaned;
a first heat exchanger, a first section of the first heat exchanger fluidly coupled to a fluid cooling system of the engine and a second section of the first heat exchanger fluidly coupled to the supply of cleaning fluid thereby transferring heat from the engine coolant to the cleaning fluid to heat the cleaning fluid and to cool the engine;
a second heat exchanger, a first section of the second heat exchanger fluidly coupled to an exhaust of the engine and a second section of the first heat exchanger fluidly coupled to the supply of cleaning fluid thereby transferring heat from the exhaust of the engine to the cleaning fluid to heat the cleaning fluid; and
a third heat exchanger, a first section of the third heat exchanger fluidly coupled to a hydraulic fluid system and a second section of the first heat exchanger fluidly coupled to the supply of cleaning fluid thereby transferring heat from the hydraulic fluid system to the cleaning fluid to heat the cleaning fluid.

19. The surface cleaning apparatus of claim 18, further comprising:
a vacuum system, an input of the vacuum system located in proximity of the nozzle system whereby the vacuum system sucks up a majority of the cleaning fluid and materials from the surface, the vacuum system filters the cleaning fluid and materials from the surface, removing a majority of the materials from the cleaning fluid and the vacuum system returns filtered cleaning fluid to the supply of cleaning fluid.

20. The surface cleaning apparatus of claim 18, wherein the engine is coupled to the wheels of the vehicle through a transmission, thereby selectively moving the vehicle across the surface under operator control.
